(19) United States
(12) Patent Application Publication
(10) Pub. No.: US 2014/0307086 A1
(43) Pub. Date: Oct. 16, 2014

(54) METHOD FOR DETERMINING DIMENSION OF SUBJECT BY USING CAMERA-EQUIPPED ELECTRONIC APPARATUS

(71) Applicant: Yamada Electric Ind. Co., Ltd., Chiba (JP)

(72) Inventors: Masuo OTA, Chiba (JP); Tsuguyoshi SADASHIMA, Chiba (JP)

(21) Appl. No.: 14/315,640

(22) Filed: Jun. 26, 2014

Related U.S. Application Data
(63) Continuation-in-part of application No. PCT/JP2012/008407, filed on Dec. 27, 2012.

(30) Foreign Application Priority Data
Dec. 28, 2011 (JP) 2011-287505

(51) Int. Cl. H04N 5/232

(52) U.S. Cl. CPC H04N 5/232
USPC 348/137

(57) ABSTRACT

A camera-equipped electronic apparatus by which an actual dimension of a subject can be easily known immediately at the time of capturing an image of the subject is provided. The camera-equipped electronic apparatus detects a size of an image of a marker and a size of the image of the subject in the captured image displayed on a display. Based on an actual dimension of the marker, the detected size of the image of the marker, and the detected size of the image of the subject, the actual dimension of the subject is computed, and the computed actual dimension is displayed on the display.

### CROSS-REFERENCE TO RELATED APPLICATIONS

This is a continuation of International Application No. PCT/JP2012/008407 filed on Dec. 27, 2012, which claims priority to Japanese Patent Application No. 2011-287505 filed on Dec. 28, 2011. The entire disclosures of these applications are incorporated by reference.

### BACKGROUND

The present disclosure relates to camera-equipped electronic apparatuses such as digital cameras, mobile phones, and portable terminals, and application programs for the camera-equipped electronic apparatuses.

In recent years, as digital cameras, camera-equipped portable apparatuses, etc. have become widespread, various subjects have been easily shot and images of the subjects have been easily recorded. So-called smart phones are configured to be able to execute various applications by downloading programs.

Japanese Unexamined Patent Publication No. H11-122518 describes a technique for determining the dimension of a subject shot by an underwater television camera based on a distance between the television camera and the subject and the number of pixels in a captured video image of the subject, the distance being measured by using an extensible gauge 21 provided to the television camera.

### SUMMARY

In some cases, one may want not only to simply shoot a subject and record an image of the subject but also to know the dimension of the subject immediately at work site or for personal interest. For example, in the field of fishing, the dimension of a caught fish may be measured. In such a case, it is very convenient if it is possible to know the dimension of the caught fish immediately when the caught fish is shot by a camera. The dimension of the fish has been commonly obtained by a proportional calculation with reference to an object which is included in the image of the fish and whose dimension has already been known.

Here, when a subject is shot by a camera provided with a distance measuring gauge as disclosed in Japanese Unexamined Patent Publication No. H11-122518, it is possible to know the dimension of the subject at the same time as the shooting of the subject. However, always bringing such a special large-scaled camera to, for example, a fishing spot is very inconvenient and impractical.

The present disclosure provides a method for determining a dimension by a camera-equipped electronic apparatus by which a user can easily know the actual dimension of a subject immediately when an image of the subject is captured.

In an aspect of the present disclosure, a method for determining a dimension of a subject by an electronic apparatus at least including a camera and a display includes steps of: (a) by the electronic apparatus, detecting a size of an image of a marker in a captured image displayed on the display and including the subject together with the marker whose actual dimension has been known; (b) by the electronic apparatus, displaying a movable indicator by which a range of an image of the subject is specified on the display, and detecting a size of the image of the subject in the captured image in response to user's operation to the movable indicator; and (c) by the electronic apparatus, computing an actual dimension of the subject based on the actual dimension of the marker, the size of the image of the marker detected in the step (a), and the size of the image of the subject detected in the step (b), and display the computed actual dimension of the subject on the display.

With this configuration, a user simply shoots a subject together with a marker whose actual dimension has been known, so that an actual dimension of the subject is displayed on a display on which captured images of the subject and the marker have been displayed. Thus, the user can easily know the actual dimension of the subject.

In another aspect of the present disclosure, a method for determining a dimension of a subject by an electronic apparatus at least including a camera and a display includes steps of: (a) by the electronic apparatus, detecting a size of an image of a marker in a captured image displayed on the display and including the subject together with the marker whose actual dimension has been known; and (b) by the electronic apparatus, displaying, on the display, a scale grid image with reference to the actual dimension of the marker on the basis of the size of the image of the marker detected in the step (a) such that the scale grid image overlaps the captured image.

With this configuration, a user simply shoots a subject together with a marker whose actual dimension has been known, so that an scale grid image is displayed on a display on which captured images of the subject and the marker have been displayed. Thus, the user can easily know an actual dimension of the subject.

In another aspect of the present disclosure, a method for determining a dimension of a subject by an electronic apparatus at least including a camera having an autofocus function and a display having a zooming function includes steps of: (a) by the electronic apparatus, fixing a focal length of the camera to a predetermined distance in response to predetermined operation by a user; (b) by the electronic apparatus, displaying a captured image on the display, the captured image including the subject shot upon completion of the step (a); (c) by the electronic apparatus, displaying, on the captured image on the display, a measurement frame whose actual dimension at a position at the predetermined distance from the camera has been known and which assists the user in performing zooming operation, and obtain a zoom ratio after the zooming operation by the user; and (d) by the electronic apparatus, computing an actual dimension of the subject based on the actual dimension of the measurement frame at the position at the predetermined distance from the camera and the zoom ratio obtained in the step (c), and display the computed actual dimension of the subject on the display.

With this configuration, a user simply shoots a subject with the focal length being fixed, and performs zooming operation on a captured image of the subject, so that an actual dimension of the subject is displayed on a display on which the captured image has been displayed. Thus, the user can easily know the actual dimension of the subject.

According to the method for determining a dimension of the present disclosure, the actual dimension of a subject can be readily known immediately when the subject is shot by a camera-equipped electronic apparatus without using a large-scaled special camera.

### BRIEF DESCRIPTION OF THE DRAWINGS

FIGS. 1A-1D are views illustrating a first operational example of a first embodiment.

FIGS. 2A-2C are views illustrating a second operational example of the first embodiment.

FIGS. 3A-3C are views illustrating a third operational example of the first embodiment.

FIGS. 4A and 4B are views illustrating a problem arising at the time of photographing at an oblique angle.

FIGS. 5A-5C are views illustrating a process for correcting an image captured at an oblique angle.

FIGS. 6A-6E are views illustrating an operation example of a second embodiment.

FIG. 7 is a view illustrating an operation example of the second embodiment.

### DETAILED DESCRIPTION

Embodiments are described in detail below with reference to the attached drawings. However, unnecessarily detailed description may be omitted. For example, detailed description of well known techniques or description of the substantially same elements may be omitted. Such omission is intended to prevent the following description from being unnecessarily redundant and to help those skilled in the art easily understand it.

Inventors provide the following description and the attached drawings to enable those skilled in the art to fully understand the present disclosure. Thus, the description and the drawings are not intended to limit the scope of the subject matter defined in the claims.

Here, an example in which a caught fish is shot by a digital camera at a fishing spot by a user will be described. That is, the description is given by taking a fish as an example of a subject, but the present disclosure is not limited to this example. Apparatuses to which the present disclosure is applicable are not limited to digital cameras, but the present disclosure is applicable to various camera-equipped electronic apparatuses such as video cameras, camera-equipped mobile phones, and smart phones.

The function of the present disclosure may be pre-installed in the camera-equipped electronic apparatuses, or programs may be downloaded to the camera-equipped electronic apparatuses similar to applications of, for example, smart phones, and the programs may be executed by a computer included in the camera-equipped electronic apparatuses, so that the function of the present disclosure can be obtained.

### First Embodiment

### <First Operational Example>

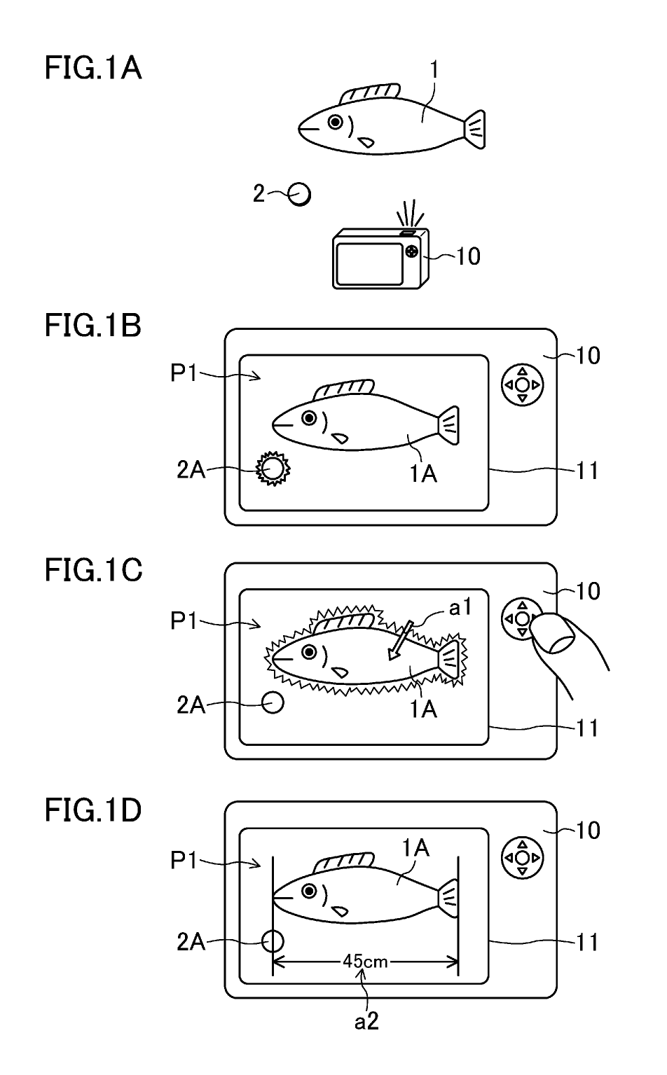

First, a user shoots a caught fish 1 together with a predetermined marker 2 by a digital camera 10 (FIG. 1A). In this embodiment, the marker 2 has a round shape in plan view. This is because when the planar shape of the marker 2 is round, an image of the marker 2 is easily recognized, and the size of the marker 2 in the image is equal to the diameter of the marker 2, that is, the marker 2 has a fixed dimension in the image irrespective of the orientation of the marker 2. The actual dimension (diameter in this embodiment) of the marker 2 is known to the digital camera 10 in advance.

The digital camera 10 displays a captured image P1 including both the fish 1 and the marker 2 on a display 11 after the shooting or in response to operation by the user (FIG. 1B). The captured image P1 includes a fish image 1A as an image of a subject and a marker image 2A which is an image of the marker 2. The digital camera 10 recognizes the marker image 2A in the captured image P1, and detects the size of the marker image 2A. To verify that the marker image 2A has been recognized, a verification notice may be output on a screen. In FIG. 1B, the contour of the marker image 2A is emphasized as an example of the verification notice.

For the image recognition here, a known image recognition processing technique may be used. When the shape of the marker 2 has been known to the digital camera 10, the image recognition can be easily executed. In order to further facilitate the image recognition, for example, the marker 2 may have a single color (e.g., a red color), or the marker 2 may have a characteristic design to allow matching with a marker image recorded in advance.

Then, the digital camera 10 recognizes the fish image 1A in the captured image P1, and detects the size of the fish image 1A (FIG. 1C). The size from the tip of the head to the tip of the tail of the fish image 1A is detected. Here, a cursor al is displayed on the captured image P1, and the user moves the position of the cursor al to specify the fish image 1A. The digital camera 10 locates and recognizes the position of the fish image 1A in response to the operation by the user. Also in this case, to verify that the fish image 1A has been recognized, a verification notice may be output on the screen. In FIG. 1C, the contour of the fish image 1A is emphasized as an example of the verification notice.

For the image recognition here, a known image recognition processing technique may be used. The fish image 1A may be recognized without the operation by the user. When a subject has a certain characteristic shape or a certain characteristic tone, an image of the subject can be relatively easily recognized. The operation by the user is not limited to moving the cursor, but for example, when the display is a touch panel, the image may be specified by touching the panel.

The detection of the size of the marker image 2A and the detection of the size of the fish image 1A may be performed in reverse order or may be concurrently performed.

The digital camera 10 computes the actual dimension of the fish 1 based on the actual dimension of the marker 2, the detected size of the marker image 2A, and the detected size of the fish image 1A. The actual dimension from the tip of the head to the tip of the tail of the fish 1 is computed. The computation can be performed by an easy ratio calculation. That is, the actual dimension X (cm) of the fish 1 can be obtained by the expression:

X=A×C/B

where A (cm) is the diameter of the marker 2, B (pixel) is the number of pixels of the diameter of the detected marker image 2A, and C (pixel) is the size from the tip of the head to the tip of the tail of the fish image 1A. For example, when A=3 (cm), B=50 (pixel), and C=750 (pixel), X=45 (cm). The digital camera 10 displays a computed actual dimension a2 on the display 11 (FIG. 1D). Thus, the user can know the actual dimension of the photographed fish 1.

### <Second Operational Example>

In the first operational example, the sizes of the marker image 2A and the fish image 1A are detected by image recognition processing, but the sizes may be detected in response to the user's operation of specifying the ranges of the marker image 2A and the fish image 1A instead of by the image recognition processing.

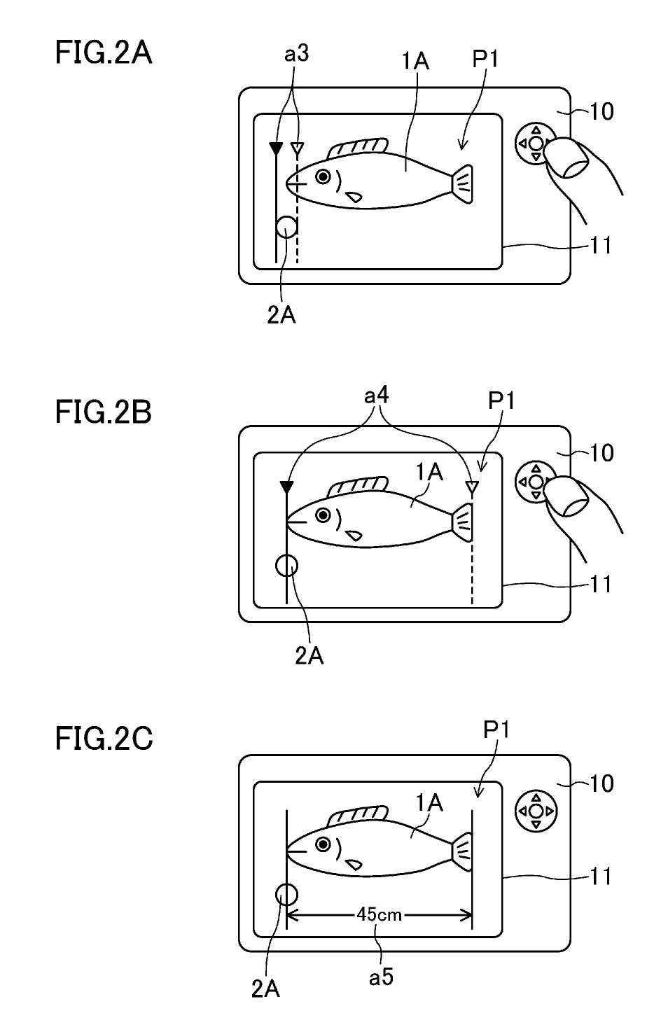

That is, the digital camera 10 displays cursors a3 as movable indicators for the marker to specify the range of the marker image 2A in the captured image P1 (FIG. 2A). The user moves the cursors a3 to specify the range of the marker image 2A. Here, the range in the lateral direction in the screen is specified as an example. When the operation by the user is completed, the digital camera 10 detects the size of the marker image 2A based on the positions of the cursors a3.

Next, the digital camera 10 displays cursors a4 as movable indicators for specifying the range of the fish image 1A in the captured image P1 (FIG. 2B). The user moves the cursors a4 to specify the range of the fish image 1A. Here, the range in the lateral direction in the screen is specified as an example. When the operation by the user is completed, the digital camera 10 detects the size of the fish image 1A based on the positions of the cursors a4.

The detection of the size of the marker image 2A and the detection of the size of the fish image 1A may be performed in reverse order or may be concurrently performed.

The digital camera 10 computes the actual dimension of the fish 1 based on the actual dimension of the marker 2, the detected size of the marker image 2A, and the detected size of the fish image 1A. The actual dimension from the tip of the head to the tip of the tail of the fish 1 is computed. Similar to the first operational example, the computation can be performed by an easy ratio calculation. The digital camera 10 displays a computed actual dimension a5 on the display 11 (FIG. 2C). Thus, the user can know the actual dimension of the photographed fish 1.

The first and second operational examples may be performed in combination. For example, the size of the marker image 2A may be detected by the image recognition processing, and the size of the fish image 1A may be detected based on the operation by the user. Alternatively, the size of the marker image 2A may be detected based on the operation by the user, and the size of the fish image 1A may be detected by the image recognition processing.

### <Third Operational Example>

In the first and second operational examples, the sizes of the marker image 2A and the fish image 1A are detected, and based on the detected sizes, the actual dimension of the fish 1 is computed. In contrast, in a third operational example, instead of computing the actual dimension of the fish 1, a scale grid image based on the actual dimension of the marker 2 is displayed such that the scale grid image overlaps the captured image.

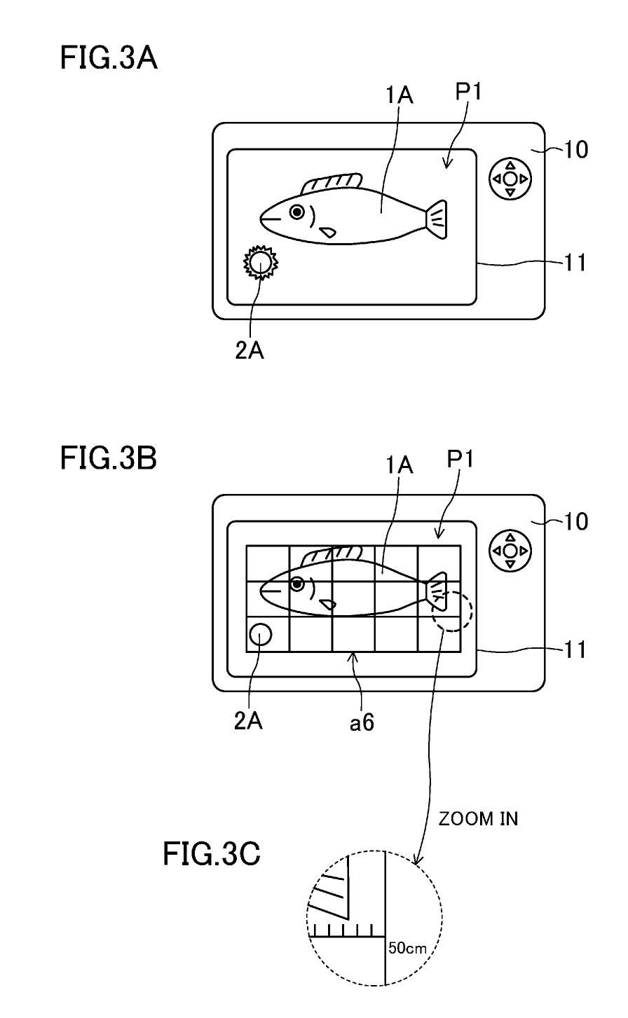

That is, similar to the first operational example, the digital camera 10 recognizes the marker image 2A in the captured image P1, and detects the size of the marker image 2A (FIG. 3A). For the image recognition here, a known image recognition processing technique may be used. To verify that the marker image 2A has been recognized, a verification notice may be output on the screen. In FIG. 3A, the contour of the marker image 2A is emphasized as an example of the verification notice. Similar to the second operational example, cursors, or the like for specifying the range of the marker image 2A may be displayed, and the size of the marker image 2A may be detected based on the positions of the cursors after the operation by the user.

Then, based on the detected size of the marker image 2A, the digital camera 10 displays a scale grid image a6 with reference to the actual dimension of the marker 2 on the display 11 such that the scale grid image a6 overlaps the captured image P1 (FIG. 3B). In this way, the user can read the actual dimension of the shot fish 1 based on the scale grid image a6. As illustrated in FIG. 3C, a zoom-in function is added, so that the dimension can be more precisely read.

In the operational examples of the present embodiment, the marker 2 has a round shape in plan view, but the planar shape of the marker 2 is not limited to the examples. The marker 2 may have a square, rectangular, hexagonal, or star shape. In the embodiment, the external size of the marker image 2A has been detected, but the present disclosure is not limited to the embodiment, and for example, the size of a pattern formed on the marker 2 may be detected. That is, the present embodiment can be implemented by using a marker 2, the actual dimension of at least part of the shape, the pattern, or the like of the marker 2 having been known.

As described above, using a round marker provides the advantage that the maximum external size is fixed irrespective of a direction in which the marker is set. Additionally, it is possible to obtain the advantages that irrespective of the shooting angle by the camera, the diameter of the marker is exhibited necessarily in the actual dimension in the captured image, and that at whichever angle the marker tilts, the diameter of the marker is exhibited necessarily in the actual dimension in the captured image. For example, when the marker image is elliptic, the length of the major axis of the ellipse corresponds to the diameter of the marker.

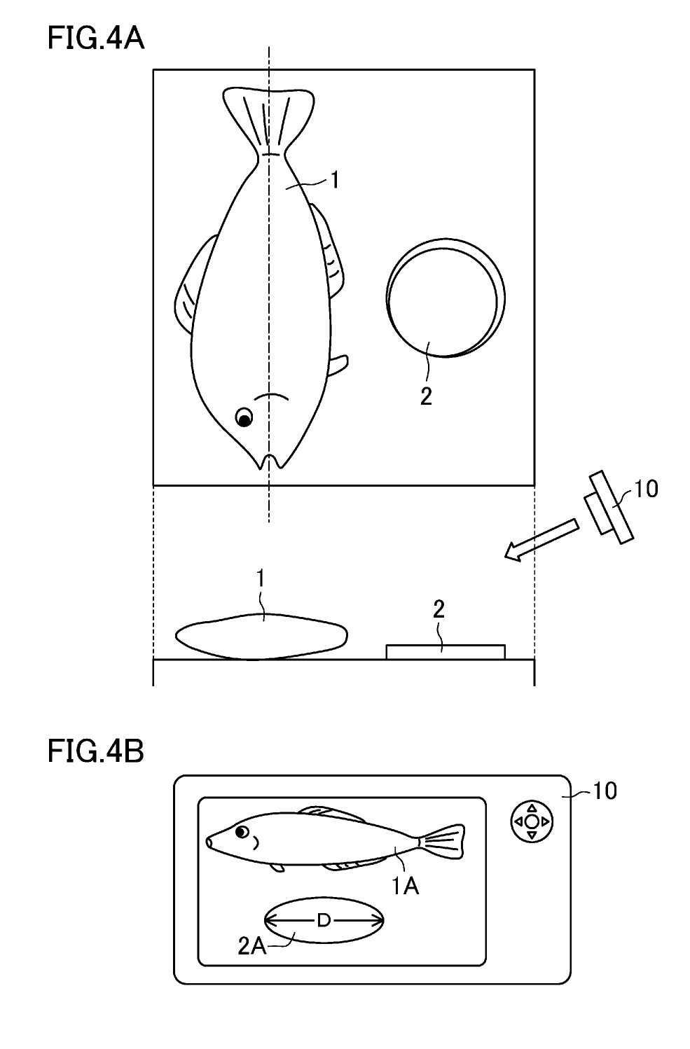

When the marker is placed on the center line of the fish, the dimensional ratio between the marker image and the fish image is not changed even when the marker and the fish are shot at an oblique angle, and thus, no problem arises. However, when the marker 2 and the fish 1 are shot at an oblique angle with the marker 2 being placed away from the center line of the fish 1 as illustrated in FIG. 4A, the dimensional ratio between the marker image 2A and the fish image 1A is changed as illustrated in FIG. 4B. In the captured image of FIG. 4B, the diameter D of the marker 2 is exhibited, but the size of the fish image 1A is reduced. Therefore, when the fish 1 is shot at an oblique angle, there is the possibility that the precise actual dimension of the fish 1 cannot be obtained.

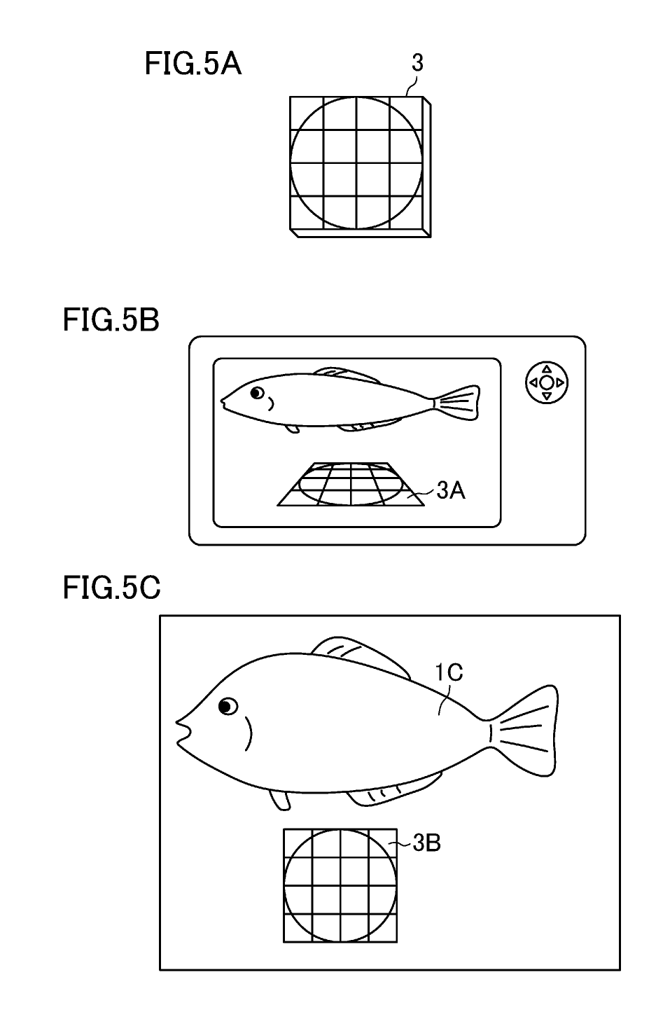

To solve the problem, there is a method in which the correct image size of the fish is assumed from the distortion of the marker image. For example, as illustrated in FIG. 5A, a marker 3 having a square shape and provided with a round pattern is used. When the marker 3 and the fish 1 are shot at an oblique angle, a captured image as illustrated in FIG. 5B is obtained. The captured image is corrected with reference to, for example, one side of the square such that the shape of the marker image 3A becomes square. The correction can be performed by, for example, known image processing software. With this correction, it is possible to obtain an image including the marker image 3B having a corrected shape and a fish image 1C having a correct size as illustrated in FIG. 5C. Then, the actual dimension of the fish 1 may be computed from the dimensional ratio between the marker image 3B and the fish image 1C.

Instead of correcting the captured image itself, the tilt of the camera assumed from the distortion of the marker image may be used to compute the correct dimension of the fish image.

The marker used here is not limited to that illustrated in FIG. 5A. For example, a marker having a round shape and provided with a pattern including a square may be used. In this case, the captured image may be corrected so that the square included in the pattern provided to the marker is correctly exhibited as a square in the image. Moreover, the marker may have a predetermined shape in plan view or a predetermined pattern other than the square shape or a square pattern. For example, when the planar shape or the pattern of the marker is round, the captured image may be corrected so that the planar shape or the pattern of the marker image becomes round. When the planar shape or the pattern of the marker is a regular triangle, the captured image may be corrected so that the planar shape or the pattern of the marker image becomes a regular triangle. That is, the captured image may be corrected so that the planar shape or the pattern of the marker image returns to the predetermined planar shape or the predetermined pattern which the marker originally has.

In the case of a marker on which a pattern is formed, a margin is preferably provided between the pattern and the outer profile of the marker. The lightness, the tone, etc. of the margin preferably have a sufficient contrast to the pattern. For example, in the case of a square pattern formed on a round marker, when the square is white, the margin of the marker outside the square is black or brown which is a color having a low lightness. A marker and a fish are placed in various sites e.g., on gravel, concrete, asphalt, etc. for dimension measurement. Therefore, the margin of the marker outside the pattern has a contrast to the pattern, which improves recognition accuracy of the marker, so that the convenience of a user is further improved.

### Second Embodiment

In the present embodiment, a digital camera has at least an autofocus function, and a display of the digital camera has at least a zoom function (zooming in and out on an image).

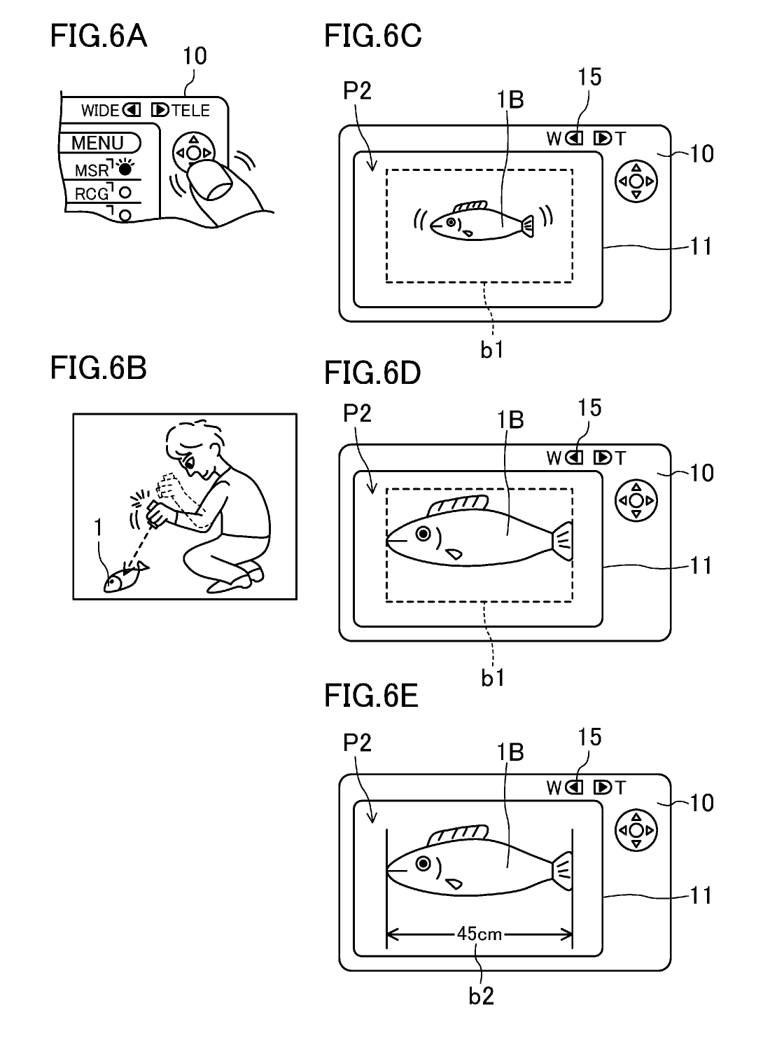

First, a user invokes a menu of a digital camera 10, and selects “measurement mode” (FIG. 6A). In response to the operation by the user, the digital camera 10 fixes its focal length to a predetermined distance. The operation by the user at this time is not limited to the operation of selecting the “measurement mode,” but may be another predetermined operation.

Next, the user shoots a caught fish 1 by the digital camera 10 whose focal length has been fixed (FIG. 6B). Here, to shoot the fish 1, the user moves the digital camera 10 to a position at which the digital camera 10 is focused on the fish 1.

Then, the digital camera 10 displays a captured image P2 including the fish 1 on a display 11. A measurement frame b1 for assisting the user in performing zooming operation is further displayed on the display 11 such that the measurement frame b1 overlaps the captured image P2 (FIG. 6C). Here, the actual dimension of the measurement frame b1 at the position of the fixed focal length from the digital camera 10 is known in advance.

The user operates a zoom button 15 to zoom in or out on the captured image P2 so that the fish image 1B matches the measurement frame b1 (FIG. 6D). Here, the user operates the zoom button 15 so that the tip of the head and the tip of the tail of the fish image 1B match the measurement frame b1. After the zooming operation by the user is completed, the digital camera 10 obtains the zoom ratio.

Then, the digital camera 10 computes the actual dimension of the fish 1 based on the actual dimension of the measurement frame b1 at the position of the fixed focal length, and the obtained zoom ratio. The actual dimension from the tip of the head to the tip of the tail of the fish 1 is computed. The computation can be easily performed by using the zoom ratio in an inverse operation. That is, the actual dimension X (cm) of the fish 1 can be obtained from the expression:

X=A/B

where A (cm) is the actual dimension (width) of the measurement frame b1 at the position of the fixed focal length, and B (power) is the zoom ratio. For example, when A=135 (cm), and B=3 (power), X=45 (cm). The digital camera 10 displays a computed actual dimension b2 on the display 11 (FIG. 6E). In this way, the user can know the actual dimension of the shot fish 1.

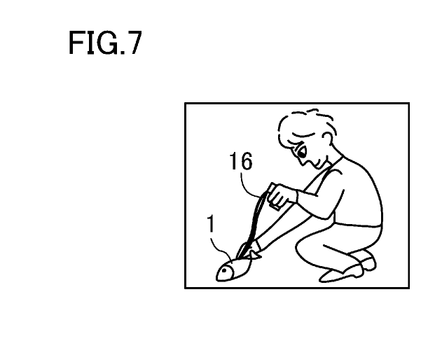

It may involve some difficulties in shooting the fish 1 in focus by the digital camera 10 whose focal length has been fixed. Therefore, for example, as illustrated in FIG. 7, a strap 16 attached to the digital camera 10 may be used so that the distance to the fish 1 matches the focal length. In this case, the focal length of the camera is fixed to a distance corresponding to the length of the strap 16.

The above-described embodiments may further include other processes. For example, after a fish image is specified and the actual dimension of the fish is computed, a so-called print image of a fish may be generated by image processing. That is, the fish image may be converted to an image in which the background including the marker image has been erased so that the background is for example, white, and the fish image is shown in a greyish black color, and the converted image may be displayed on the display together with the computed actual dimension of the fish. Here, shooting date, etc. may also be displayed.

By an image matching process, the species of a fish may be automatically determined. That is, shooting date and time are recorded together with a captured image, so that from the shooting date and time, it is possible to know the season or the time of the day in which the fish was shot. When the electronic apparatus has a GPS function, the shooting location can be recorded together with the captured image, so that from the shooting location, it is possible to know the location where the fish was shot. Of course, the shooting date and time or the shooting location may be input by a user. With reference to the shooting date and time, the shooting location, the computed actual dimension of a fish, and the fish image of the captured image, the user accesses, via the internet, a database in which, for example, information about characteristics of fishes is collected, so that the species of the fish can be determined. For example, the external shape, the pattern, etc. can be used as the characteristics of the fish image. As a result of determination, options of species having a high possibility of corresponding to the species of the fish may be shown on the display, and may be eventually selected by a user.

Based on the determined species and the computed actual dimension of the fish, the weight of the fish may be estimated. That is, once the species of the fish is determined, the relation between the dimension and the weight of the fish may almost be determined. Therefore, for example, when a database storing the relationships between the dimensions and the weights corresponding to the species of fishes is accessed via the internet, the weight of the fish can be estimated based on the determined species and the computed actual dimension of the fish. Here, the area occupied by the fish image in the captured image may be obtained, and the obtained area may be used for the estimation of the weight of the fish.

Although a fish has been taken as an example of a subject in the above embodiments, the present disclosure is not limited to the embodiments. For example, the present disclosure can be used to various subjects for various purposes such as academic research, marketing research, or investigation of a case. Although the dimension from the tip of the head to the tip of the tail of a fish has been determined in the above embodiments, the actual dimension to be computed is not limited to this, and depending on subjects, for example, the height, the width, the length, etc. can be computed.

According to the present disclosure, the dimension of a subject can be easily determined at the same time of capturing and recording an image of the subject, so that the present disclosure is useful, for example, in the field of hobbies such as recording and ranking results of fishing, in the field of academic research, business, or the like.

What is claimed is:

1. A method for determining a dimension of a subject by an electronic apparatus at least including a camera and a display, comprising steps of:
(a) by the electronic apparatus, detecting a size of an image of a marker in a captured image displayed on the display and including the subject together with the marker whose actual dimension has been known;
(b) by the electronic apparatus, displaying a movable indicator by which a range of an image of the subject is specified on the display, and detecting a size of the image of the subject in the captured image in response to user's operation to the movable indicator; and
(c) by the electronic apparatus, computing an actual dimension of the subject based on the actual dimension of the marker, the size of the image of the marker detected in the step (a), and the size of the image of the subject detected in the step (b), and display the computed actual dimension of the subject on the display.

2. The method of claim 1, wherein
a planar shape or a pattern of the marker is predetermined, and
before the step (a), the electronic apparatus corrects the captured image such that a planar shape or a pattern of the image of the marker becomes the predetermined planar shape or the predetermined pattern of the marker.

3. The method of claim 1, wherein
the subject is a fish, and
the electronic apparatus determines a species of the fish based on shooting date, time, and location of the captured image, an actual dimension of the fish computed in the step (c), and the image of the fish.

4. The method of claim 3, wherein
the electronic apparatus estimates a weight of the fish based on the determined species of the fish and the actual dimension of the fish computed in the step (c).

5. The method of claim 1, wherein
the subject is a fish, and
the electronic apparatus erases a background image including the image of the marker, converts the image of the fish to an greyish black image, and displays the greyish black image together with the computed actual dimension of the fish on the display.

6. The method of claim 1, wherein
in the step (a), a movable indicator for the marker to specify a range of the image of the marker is displayed on the display, and the size of the image of the marker is detected in response to user's operation to the movable indicator for the marker.

7. The method of claim 1, wherein
the marker has a round shape in plan view.

8. A method for determining a dimension of a subject by an electronic apparatus at least including a camera and a display, comprising steps of:
(a) by the electronic apparatus, detecting a size of an image of a marker in a captured image displayed on the display and including the subject together with the marker whose actual dimension has been known; and
(b) by the electronic apparatus, displaying, on the display, a scale grid image with reference to the actual dimension of the marker on the basis of the size of the image of the marker detected in the step (a) such that the scale grid image overlaps the captured image.

9. A method for determining a dimension of a subject by an electronic apparatus at least including a camera having an autofocus function and a display having a zooming function, comprising steps of:
(a) by the electronic apparatus, fixing a focal length of the camera to a predetermined distance in response to predetermined operation by a user;
(b) by the electronic apparatus, displaying a captured image on the display, the captured image including the subject shot upon completion of the step (a);
(c) by the electronic apparatus, displaying, on the captured image on the display, a measurement frame whose actual dimension at a position at the predetermined distance from the camera has been known and which assists the user in performing zooming operation, and obtain a zoom ratio after the zooming operation by the user; and
(d) by the electronic apparatus, computing an actual dimension of the subject based on the actual dimension of the measurement frame at the position at the predetermined distance from the camera and the zoom ratio obtained in the step (c), and display the computed actual dimension of the subject on the display.

10. The method of claim 9, wherein
in the step (a), the focal length of the camera is fixed at a distance corresponding to a length of a strap attached to the electronic apparatus.

11. An electronic apparatus at least comprising:
a camera; and
a display, wherein
the electronic apparatus is configured so as to be able to perform
a step (a) of detecting a size of an image of a marker in a captured image displayed on the display and including a subject together with the marker whose actual dimension has been known;
a step (b) of displaying a movable indicator by which a range of an image of the subject is specified on the display, and detecting a size of the image of the subject in the captured image in response to user's operation to the movable indicator; and
a step (c) of computing an actual dimension of the subject based on the actual dimension of the marker, the size of the image of the marker detected in the step (a), and the size of the image of the subject detected in the step (b), and displaying the computed actual dimension of the subject on the display.

12. A computer-readable recording medium storing a program for causing the electronic apparatus to execute the method of claim 1.
